(19) United States
(12) Patent Application Publication
(10) Pub. No.: US 2006/0266187 A1
(43) Pub. Date: Nov. 30, 2006

(54) Veneer clipper roll cover with curtain-screen armature

(75) Inventor: John E. Hards, West Vancouver (CA)

Correspondence Address: ROBERT D. VARITZ, P.C., 4915 SE 33RD PLACE, PORTLAND, OR, 97202, US

(73) Assignee: Industrial Equipment Manufacturing, Ltd

(21) Appl. No.: 11/129,979

(22) Filed: May 15, 2005

(51) Int. Cl. B26D 1/24

(52) U.S. Cl. 83/502

(57) ABSTRACT

Anvil roll cover structure for a veneer clipper comprising, plural, complementary, molded roll cover sections having curved chevron-cut shapes assembleable in pairs to form a unified, singular, circumsurrounding anvil roll cover segment. The sections which unite to form cover segments are supported internally by curtain-screen, wire-mesh, flex armature components which help to stabilize segment section shapes which are formed by chevron-cutting of initially whole, molded, undivided cover segments. Joinery-accommodating nut, bolt and passage structures operatively associated with pairs of segment sections accommodate assembly of such pairs into full body-of-revolution segments. End-to-end disposed, twin-section segments collaborate to form an overall anvil roll cover.

### BACKGROUND AND SUMMARY OF THE INVENTION

This invention relates to veneer clipping, and in particular to a unique chevron-sectioned and segmented anvil roll sleeve structure, or cover, which is useable on the anvil roll in a veneer clipper and which is internally supported by a special curtain-screen armature.

A currently pending U.S. patent application, Ser. No. 10/717,014, filed Nov. 19, 2003, for “Veneer Clipper Anvil Roll Jacket and Related Methodology”, illustrates and describes a predecessor to the present invention. For background purposes, the full disclosure content of that prior-filed application is hereby incorporated herein by reference.

In this prior-filed patent application, what is disclosed is an endo slide-on, and later removable and replaceable, clipper anvil-roll cover, or sleeve structure, which takes the form of plural, end-to-end abutting sleeve segments which are molded to correct shape and size, with each possessing an annular, or tubular, body of revolution formed of a suitable, resilient polyurethane material. The polyurethane mold material employed for these sleeve segments is supported by an internal, expanded-metal armature. These molded segments are installed by sliding and moving them endo, and into next-adjacent abutting relation, onto an uncovered, typically steel, core anvil roll. When the time comes for replacement, the sleeve segments are slid off of the roll, and new segments are installed. Installation and removal requires temporary removal of the steel core anvil roll.

The present invention focuses attention on simplifying the installation and later removal of an anvil roll sleeve segment which is somewhat like that shown and described in the mentioned prior patent application. In particular, it proposes a unique longitudinally split, or sectional, molded anvil roll sleeve segment which is illustrated herein in a preferred and best mode version of the invention as a two-part, two-section organization. These two parts, or section bodies, which result from a special chevron cutting/splitting of an originally mold-formed, tubular singularity, are substantially identical and complementary in construction, and are thus configured for quick, lateral, radial-motion placement on an anvil roll, followed by easy securement to one another to form what is referred to herein as a segment. Each of these complementary parts, or segment sections, has a shape which forms a portion of an elongate, angular body of revolution, and when looked at from an end, and along its “axis of revolution”, is seen to occupy somewhat more than 180° of a circular arc. As will be seen, this more than 180° arc-subtending feature allows each segment section to be slipped laterally (radially) onto the cylindrical outside surface of an anvil roll from a side of that roll, and in the process to be “self-capturing” on the roll so as to avoid the need for any additional positional stabilization while its companion and complementary segment section is also slipped onto the roll for co-securement with its matching companion. Importantly, the sleeve structure thus proposed by the present invention can be easily installed and removed without requiring removal from a clipper of the heavy, steel, core anvil roll. Each complementary section of a sleeve segment, when laid out flat in a “developed” condition, and as will be seen, possesses the perimetral outline of a chevron.

Another feature of the invention involves the use, in the molded body of each sleeve part, or section, of a special form of coil, flex-chain, wire-mesh armature which differs from the expanded-metal armature included in the sleeve segments mentioned earlier herein in relation to the referenced prior U.S. patent application. The armature employed in accordance with the present invention, as just mentioned, takes the form of a coil flex-chain wire mesh generally of the kind employed frequently in conventional fireplace screens—a mesh in which there is sufficient play between adjacent elongate runs of coiled wire to permit the overall mesh formed from those runs to lengthen and collapse a significant amount in one direction (transverse to the long dimensions of the coils). The reason for employing this type of mesh involves avoiding a condition of pre-stress distortion in the ultimately cut-apart two segment parts (sections) which are prepared by cutting, into two curved chevron components, an original, molded, singular, cylindrical segment. This will be explained below in conjunction with a description of the process for constructing the sleeve segment sections of the invention.

These and other features and advantages which are offered by the invention will become more fully apparent as the description which now follow is read in conjunction with the accompanying drawings.

### DESCRIPTION OF THE DRAWINGS

FIGS. 1A and 1B provide two, fragmentary, isometric views of a veneer clipper having an anvil roll covered by two-part, chevron-sectioned sleeve segments having molded segment-section bodies made in accordance with a preferred and best-mode embodiment of the invention.

FIG. 2 is a fragmentary side view illustrating an isolated installation of a pair of sleeve sections in one of the sleeve segments shown in FIG. 1.

FIG. 3 is a sectional view taken generally along the line 3-3 in FIG. 2. Sectional cross-hatching has been omitted in this figure in order to simplify this view.

FIGS. 4A and 4B, respectively, provide an exploded schematic version effectively of FIG. 3, and a flat “developed” view, to illustrate how chevron-cut sleeve sections made in accordance with practice of the present invention look, and may be placed on and removed from an anvil roll.

FIGS. 5 and 6 illustrate, in two different conditions, fragments of the special form of wire mesh armature employed in the sleeve structure of this invention.

FIGS. 7-9, inclusive, help to illustrate the making and installation of the sleeve structure of the invention.

### DETAILED DESCRIPTION OF THE INVENTION

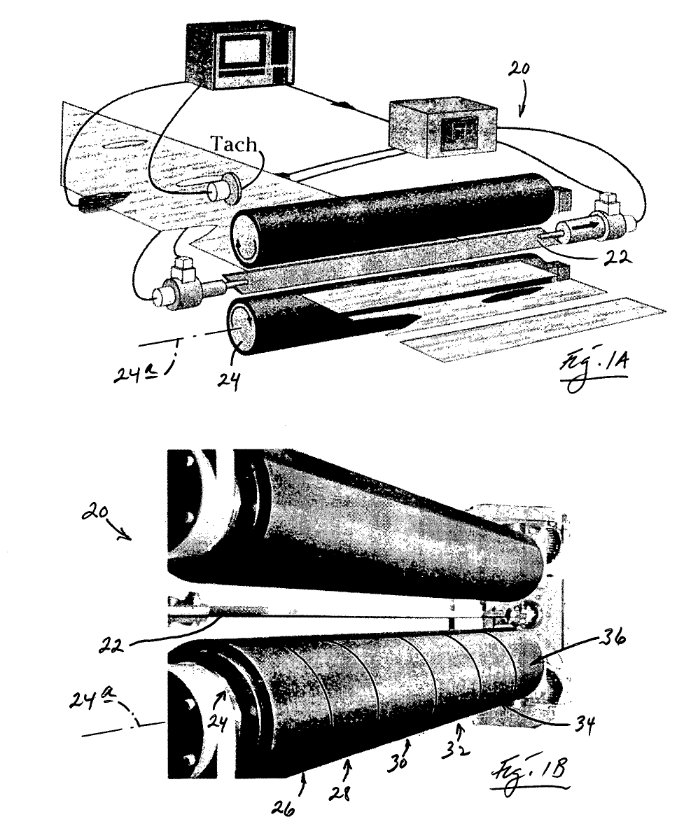

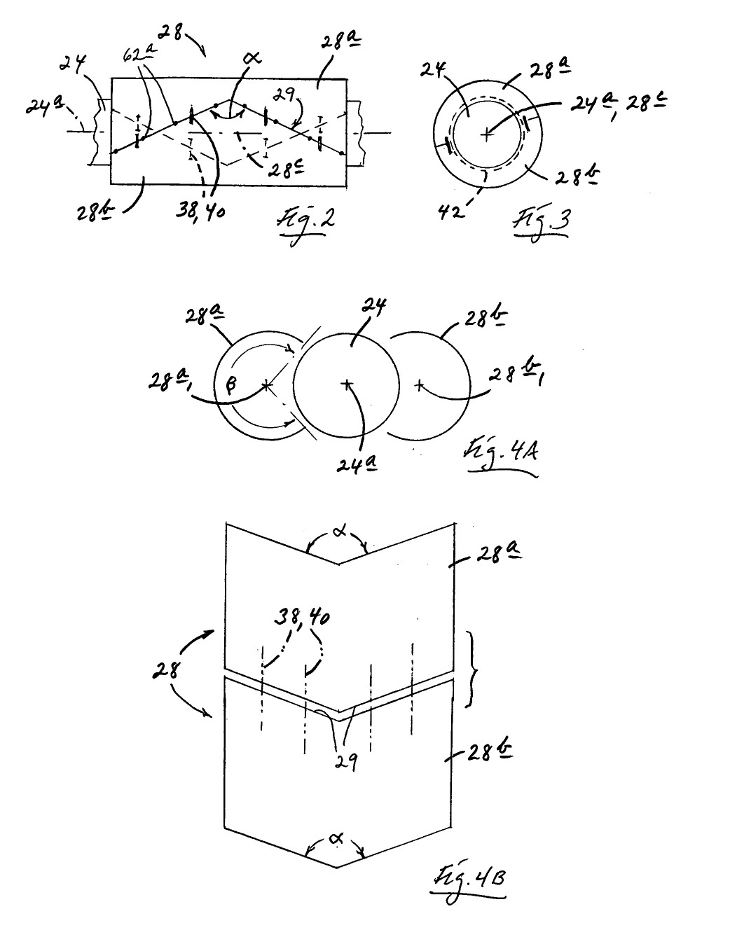

Beginning with a discussion relating to subject matter illustrated particularly by FIGS. 1-4B, inclusive, in the drawings, indicated generally at 20 in FIGS. 1 and 2 is a portion of a veneer clipper which, but for the incorporation of the structure of the present invention, is otherwise conventional in construction. Included in clipper 20 is the usual elongate, rotary, clipper knife 22 which is disposed appropriately adjacent an elongate, rotary anvil roll 24 supported for rotation about an axis (a rotary axis) 24a. Roll 24 is covered by plural, annular, two-section, cylindrical sleeve, or cover, segments 26, 28, 30, 32, 34, 36 which are constructed in accordance with the present invention. These segments fit snuggly, with what can be thought of as being a bare-clearance, substantially interference fit, on the outside diameter (substantially 9½-inches herein) of anvil roll 24. The outside diameter of each of these segments herein is substantially 11½-inches, and the axial length of each is substantially 30-inches.

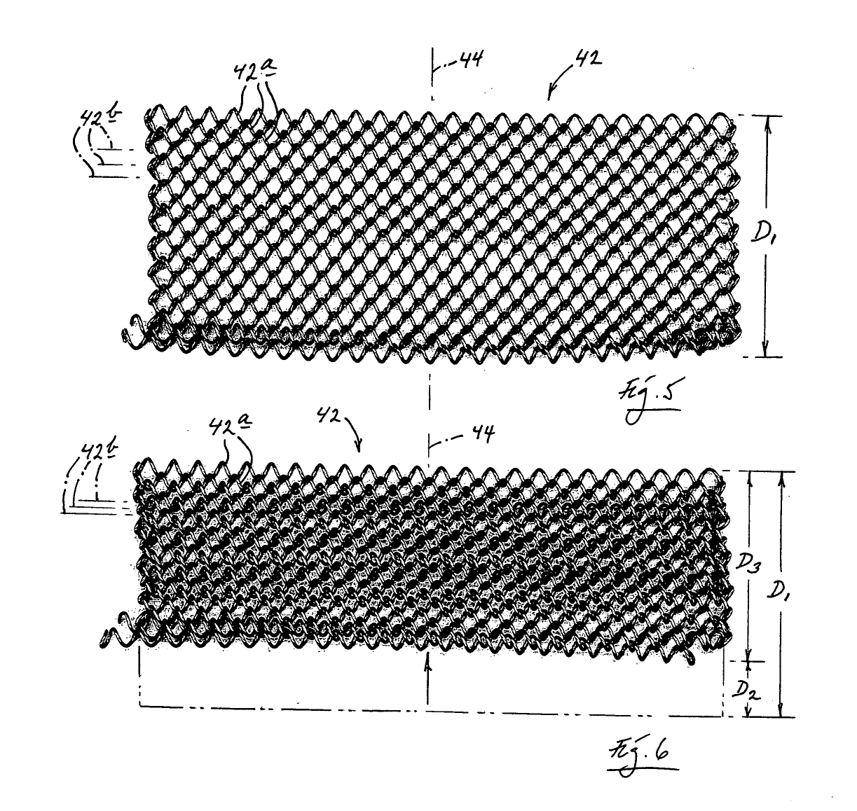

FIGS. 2, 3, 4A and 4B focus attention particularly on two-section, or two-part, sleeve segment 28 which will serve to illustrate the construction of each of the six pictured segments. In FIGS. 2 and 3, the two sections (soon to be described) of segment 28 are fastened in place on anvil roll 24. In FIG. 4A, they are shown unmounted on this roll. In FIG. 4B, they are shown isolated and flattened, or developed.

Segment 28 includes two, duplicate and fittingly complementary half-sections, or parts, 28a, 28b which are chevron-cut, as illustrated (see especially FIG. 4B where opposite sides of such a cut are shown at 29), on diametrally opposite sides, with the angle α which exists at the “peak” of the chevron cut shown herein being about 150°. As can be seen in FIG. 4A, and as will be noted again later, segment sections 28a, 28b , when viewed along their long axes 28a₁, 28b₁, as in FIG. 4A, are seen each to subtend an arc β having an angular size which is greater than 180°. This common condition of the two segment sections plays an important role both in the installation and in the removal of the segment sections with respect to a core anvil roll.

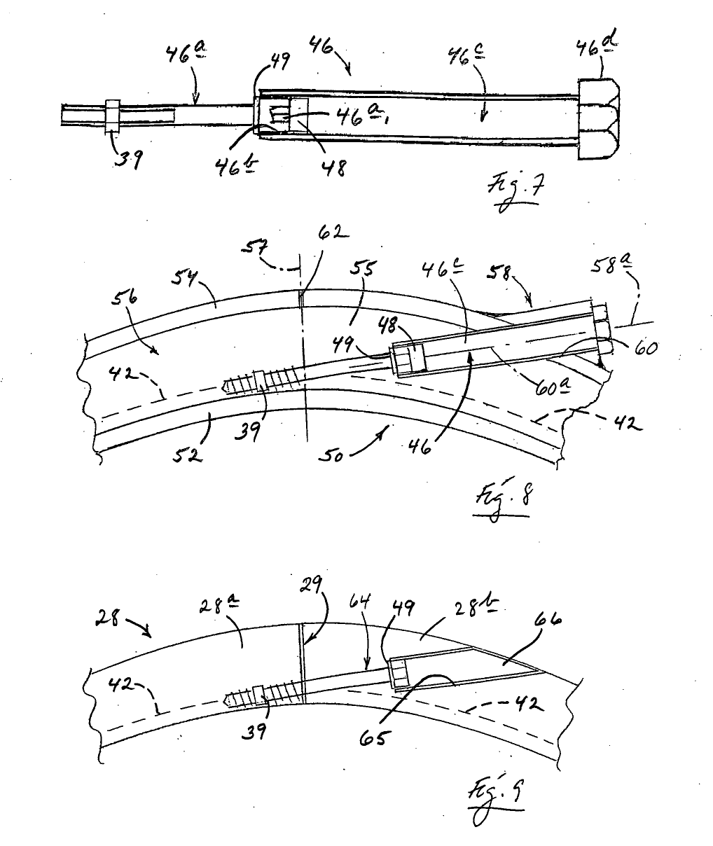

Looking now additionally at FIG. 9 which furnishes a detail view of complementary fitment of sections 28a, 28b along labeled chevron cut 29, these two complimentarily fitting sections (a) join along chevron-shaped lines, (b) are closed tightly upon the outside of anvil roll 24, and (c) are held in place by deeply, molded-hole-recessed Allen bolts (four per side—eight in all) 38 whose socket-head ends are concealed by Nylon® plugs 40 which are screwed into the outer reaches of the holes, or passages, that receive the bolts. The threaded ends of these bolts engage mold-embedded nuts 39 whose presence and availability for this purpose will be explained shortly. Plugs 40 are cut off substantially to match the outer curvature of the sleeve sections' outer surfaces. Greater details about these bolts and plugs, and about the conditions prepared for attachment of two segment sections, will be explained later with references made to FIGS. 7-9, inclusive.

Dashed and solid lines in FIG. 2, and dash-double-dot lines in FIG. 4B, represent the locations and lines of placement of bolts 38 and plugs 40, and are so labeled with these two numbers. The assembled sleeve sections thus come together to form a complete sleeve segment having the earlier-mentioned outside diameter of about 11½-inches, with the wall thickness of each sleeve section (and assembled segment) being, therefore, substantially 1-inch. Each fully assembled sleeve segment has a long central axis which substantially coincides with anvil roll axis 24a when installed on the anvil roll. In FIGS. 2 and 3, this substantial coincidence is shown with respect to anvil roll axis 24a and axis 28c of assembled segment 28. The bolts, nuts and accommodating passages (mold holes) via which two sleeve sections are secured to one another are referred to collectively as joinery-accommodating structure. The bolts per se are also referred to herein as screw-adjustable fastening devices.

Included in each segment section, near the inner diameter thereof, is a special, stabilizing, flex-chain, wire-mesh, curtain-screen armature component which is herein given the reference numeral 42. Digressing for a moment to look at FIGS. 5 and 6 which show a piece of such an armature in two different conditions, this armature structure takes the form of an extendible/collapsible, curtain-like, flex chain including plural, intertwined, elongate coil runs 42a. These runs have substantial “play” between them especially “along a line” of relative motion (see dash-dot line 44) which is orthogonal (transverse) to their long axes 42b. An important consequence of this construction is that the armature mesh can be lengthened along this line, as shown in FIG. 5, or shortened/collapsed, as shown in FIG. 6. For a mesh expanse having a full, “lengthened” dimension D₁ (see FIG. 5), this expanse can be collapsed along line 44 by an amount D₂ (see FIG. 6) to have a fully “collapsed” dimension D₃ (see also FIG. 6).

Mesh armature components 42 are disposed in the assembled sleeve segments in a manner whereby the axes 42b of the coil runs substantially parallel the long, central axis, such as axis 28c, of these segments. The reason for this selected mesh orientation will be explained shortly.

Each assembled, two-section sleeve segment which is made in accordance with this invention “began its life”, so-to-speak, as a singularity segment—namely, as one unitary, undivided structure—which is later cut apart to form the two, like, complementary segment sections which have just been described. This manufacturing approach has been determined to embody the best currently known mode (of several) for creating the easily installed and removed anvil-roll cover, or sleeve, structures of the present invention.

FIGS. 7-9, inclusive, illustrate the preferred manner of building the anvil-roll cover/sleeve segments, and their complementary, two sections, of the invention.

Beginning with FIG. 7, illustrated generally at 46 is a two-piece mold pin which is employed during the mold-formation of a singular and yet undivided sleeve segment. This mold pin includes a 5/16-inches diameter, standard-thread, steel, Allen-head bolt 46a, which is threaded about one-half way along its shank, and whose head 46a₁ is seated in an end socket 46b in a larger-diameter (about ½-inches, O.D.) outside-threaded, cylindrical screw component, or screw, 46c having an appropriate length, and a driving end 46d which may also be of an Allen-socket-drive nature. A suitable, small, cylindrical, permanent magnet 48 serves initially to retain bolt head 46a₁ in socket 46b. Previously mentioned nut 39, which ultimately becomes captured (mold embedded) in a segment section, is screwed about one-half way along the threaded portion of the shank in bolt 46a, and a washer 49 (which also becomes mold captured in a segment section) is disposed on this shank next to the “underside” of bolt head 46a₁.

Shown fragmentarily at 50 in FIG. 8 is an elongate tubular mold having suitable inner and outer metal wall structures 52, 54, respectively, which collectively define a mold void space 56 into which polyurethane mold material 55 is introduced to create an anvil-roll cover segment. Appropriate, but not illustrated, mold-closure end pieces are provided against axially opposite ends of wall structures 52, 54. Also, an appropriate mold-material infeed structure (not shown) is provided. Shown by a dash-dot line at 57 in FIG. 8 is the site, in the plane of this figure, of a portion of a future (post-molding) chevron cut (one of two) which will be made to divide a molded-segment singularity into two sections, such a sections 28a, 28b.

Welded at appropriate plural locations around and along the outside of outer wall 54 are elongate, angularly disposed tubular bosses, such as boss 58. The elongate hollow interiors of bosses 58 have their long axes 58a substantially coincident with the axes, such as axis 60a, of bore holes, such as bore hole 60, formed in outer wall structure 54. Bore holes 60 have substantially the same diameters as that of the cylindrical interiors of tubular bosses 58. These diameters afford a clearance fit for a mold-pin screw 46c.

The diametrically opposite sides of outer wall structure 54 in mold 50 are provided each with four sets of “aligned” bosses 58 and bore holes 60 distributed along angular lines which will define where a molded, singular cover segment will be chevron-cut. In each such set of four, the central boss and aligned bore hole reside adjacent the location where the later angular chevron cut will occur.

Small, outer-end plugged witness holes, such as hole 62 shown in FIG. 8 herein, having a diameter of about 3/32-inches, are distributed in outer wall structure 54 to create, during molding of a segment, outwardly protruding, tiny marker islands to indicate with precision just where the later-intended chevron cuts are to be made. These islands disappear with chevron cutting. Notwithstanding this eventual disappearance, FIG. 2 is marked with small black dots, numbered 62a, to indicate how a plurality of such witness holes and resulting islands might be distributed. Bosses 58, bore holes 60, and witness holes 62 are disposed in such a relative-position fashion that the eventually made segment-dividing chevron cuts will slice precisely through the regions where, as will now be explained, the shanks in bolts 46a reside during molding.

To produce a cover segment and its ultimately created, two sections, mold 50 is assembled, with a set of eight two-part mold pins 46 inserted in bosses 58 so as to extend into void space 56, as shown in FIG. 8.

Prior to closing of the mold, an appropriate expanse of wire mesh armature material 42 is wrapped and suitably secured around the outside of inner mold wall structure 52. In particular, this armature material is so wrapped under a condition of slight tension so as to expand it fully in the manner described earlier herein with respect to line 44 in FIG. 5. The mesh armature material is wrapped in a manner whereby coil axes 42b will substantially parallel the later-resulting central-axis of revolution, such as axis 28c, of a molded segment, such as segment 28. In the known regions to which the inner threaded ends of mold-pin bolts 46a will extend when the mold pins are installed just before a molding procedure, an appropriate small “clearance” portion (not illustrated) of the armature material is removed.

The significance of using mesh armature material as described recognizes the fact that molded polyurethane material tends to attempt to shrink internally during mold curing of this material. Such a shrinkage tendency, when associated with a “fixed-dimension” mesh material, has been found to introduce stresses in the polyurethane material, which stresses, following cutting of a singular, molded cover segment to create two complimentary halves, would relax, and thereby distort the final shapes and sizes of the two cut-separated sections in a manner preventing them from fitting snuggly and properly on the outside surface of a core anvil roll. Material 42 does not do this because of its ability to collapse (as illustrated in FIG. 6) during polyurethane curing so as to avoid a shrinkage-tendency stress build-up of the nature just described. An important consequence is that cut-divided segment sections prepared from an initial molded segment singularity retain their intended final shapes which will properly fit snuggly and correctly on an anvil roll without any unwanted “inter-section” gaps appearing.

With mold 50 fully prepared, a suitable resilient polyurethane mold material is introduced and allowed to cure. After such curing, the two-part mold pins are unscrewed and removed leaving nuts 39 and washers 49 molded (captured) in place. The mold is opened to release the then-formed segment singularity, and, guided by the earlier mentioned, small, protruding witness islands, the segment is precision chevron-cut to create the desired, two, complementary segment sections. The witness islands disappear with such cutting, and the two complementary segment sections are ready for use. Each of these segment sections has a shape with an associated axis of revolution, and which thus forms a portion of a annular body of revolution—i.e., the assembled segment of which it will form a part.

To perform an installation, the knife in the relevant clipper is removed to a safe location, and the operating power connection to the clipper is opened. Current anvil roll cover structure is removed without necessarily requiring the removal of this roll itself from the clipper. Then, a new overall cover is installed, segment-by-segment, by placing confronting cover sections laterally (radially) onto the surface of the roll. The fact that each segment section subtends an arc which is greater than 180° results in each section self-gripping and capturing itself in a suitably stabilized condition on the anvil roll, whereby no auxiliary assistance is needed to accomplish this.

The two segment sections which complimentarily confront one another are secured to one another through Allen-head bolts, such as bolt 64 seen in FIG. 9. The threaded shanks in bolts 64 engage with embedded nuts 39, and the undersides of the heads in these bolts become seated against embedded washers 49. Threaded filler plugs formed, for example, of Nylon® are screwed onto the molded-in access holes 65 which are exposed on the outside surfaces of the segment sections, and projecting portions of these plugs are suitably cut off to create curved-surface continuity with the adjacent outside segment-section surfaces. Such a cut-off plug is shown at 66 in FIG. 9.

The clipper is then restored to full operating condition, with the knife returned to its place, and the operating power connection re-established. The chevron “seams” which exist between connected sleeve sections form acute angles with the edge of the clipper knife, thus preventing the knife, during clipper operation, from “dropping into” a joint, or seam, between segment sections.

When the time comes for anvil-roll cover replacement, the clipper knife is again removed, and the power supply connection interrupted. Saw cuts are then made to slice through bolts 64, thus to free the cover segment sections for quick and easy lateral (radial) removal from the anvil roll. New cover-segment sections are then installed as described just above.

Variations, where desired, may readily be made in the approach to implementing the invention. Roll-cover segments, and split, complementary segment sections, can be made in different sizes. Chevron cuts in molded segments may be made at different angles. Techniques other than bolting may be employed to fasten two segment sections together. For example, press-fit pinning may be employed, with appropriate steps taken to assure that all pinned-together sites are essentially identical in “pinning force”.

Other variations will come to the minds of those generally skilled in the art, and it is intended that all such variations will come within the scope and spirit of the invention.

I claim:

1. Anvil roll cover structure for a veneer clipper comprising
plural, complementary roll cover sections assembleable in pairs to form, form each pair, a unified, singular, circumsurrounding anvil roll cover segment, and
joinery-accommodating structure operatively associated with said pairs of sections accommodating assembly of the same to form a segment.

2. The structure of claim 1, wherein said joinery-accommodating structure includes elongate, axially alignable pairs of passages formed in said pairs of sections.

3. The structure of claim 2 which further comprises screw-adjustable fastening devices insertable each in axially aligned pairs of said passages.

4. The structure of claim 1 with respect to which an associated anvil roll has a rotary axis, and wherein said cover sections and said joinery-accommodating structure are configured to promote assembly of the cover sections with radial inward lateral shifting of the cover sections toward the rotary axis of the anvil roll.

5. The structure of claim 1, wherein each of said cover sections includes a molded body, and a flex chain mesh armature embedded in said body.

6. The structure of claim 4, wherein each of said cover sections includes a molded body, and a flex chain mesh armature embedded in said body.

7. The structure of claim 1, wherein each cover section for a segment has a shape which forms a portion of an annular body of revolution.

8. The structure of claim 7, wherein each of said shapes has an associated axis of revolution, and when viewed along that axis, is seen to subtend an angle greater than 180°.

9. The structure of claim 1, wherein a formed segment has an axis of revolution, and the sections in that segment meet along lines which lie at acute angles relative to said axis.

10. The structure of claim 1, wherein the sections in a pair of assembled roll cover sections meet along chevron-shaped lines.
